(19) United States
(12) Patent Application Publication
(10) Pub. No.: US 2010/0004938 A1
(43) Pub. Date: Jan. 7, 2010

(54) SOFTWARE LICENSING SYSTEM

(75) Inventors: Arne Sundstrom, Vasteras (SE); John Halderson, Doylestown, PA (US); Volker Dunklau, Velbert (DE)

Correspondence Address: VENABLE LLP, P.O. BOX 34385, WASHINGTON, DC, 20043-9998, US

(73) Assignee: ABB AB, Vasteras (SE)

(21) Appl. No.: 11/794,569

(22) PCT Filed: Dec. 30, 2005
(86) PCT No.: PCT/US2005/047352

§ 371 Date: Sep. 24, 2009

Related U.S. Application Data
(60) Provisional application No. 60/639,997, filed on Dec. 30, 2004.

(51) Int. Cl. G06Q 99/00; G06Q 50/00; G06F 21/22

(52) U.S. Cl. 705/1; 726/26

(57) ABSTRACT

A software management method, including storing customer identifying information in a customer register, storing a subscription agreement of a customer in a subscription agreement register, creating at least one license corresponding to the subscription agreement, storing the license in a license register, generating at least one key corresponding to a scope of the license, and providing the key to the customer.

### FIELD OF THE INVENTION

The invention relates to a method for managing software agreements, licenses, key generation and distribution, access control and delivery. The present invention also relates to a computer program and system for carrying out the method.

### BACKGROUND OF THE INVENTION

Historically, hardware was perceived as a primary money making component of a system. On the other hand, software was viewed by some as just a necessary evil to complete the system. Typically, hardware was sold and the software was given away.

However, as time has passed, this paradigm has changed. Along these lines, in the computer industry, software is becoming the primary profit component of a system. Hardware is becoming a commodity.

Hardware is relatively easy to manage in that it has physical form that is not easily duplicated. On the other hand, software may be easily copied and transmitted about. The ease with which software may be duplicated males it a great source of potential revenue loss, particularly as the emphasis and value have shifted from hardware to software.

### SUMMARY OF THE INVENTION

The invention helps to manage the sale, licensing, distribution and access to software through a method and system. The method includes storing customer identifying information in a customer register, storing a subscription agreement of a customer in a subscription agreement register, creating at least one license corresponding to the subscription agreement, storing the license in a license register, generating at least one key corresponding to a scope of the license, and providing the key to the customer.

The present invention also includes a computer program product including a computer readable form and computer program instructions encoded on the computer readable form for carrying out the method. Additionally, the invention includes a system including a processor and a memory operable to store computer program instructions executable by the processor for performing the method.

Further objectives and advantages, as well as the structure and function of exemplary embodiments will become apparent from a consideration of the description, drawings, and examples.

### BRIEF DESCRIPTION OF THE DRAWINGS

The foregoing and other features and advantages of the invention will be apparent from the following, more particular description of an exemplary embodiment of the invention, as illustrated in the accompanying drawings wherein like reference numbers generally indicate identical, functionally similar, and/or structurally similar elements.

FIG. 1 represents a schematic drawing representing elements of an embodiment of a system according to the present invention;

FIG. 2 represents a schematic drawing representing elements of an embodiment of a system according to the present invention;

FIG. 3 represents a schematic drawing representing elements of an embodiment of a system according to the present invention;

FIG. 4 represents a schematic drawing representing elements of an embodiment of a system according to the present invention;

FIG. 5 represents a schematic drawing representing elements of an embodiment of a system according to the present invention;

FIG. 6 represents a schematic drawing representing elements of an embodiment of a system according to the present invention;

FIG. 7 represents a schematic drawing representing elements of an embodiment of a system according to the present invention;

FIG. 8 represents an embodiment of screen shot of a user interface according to an embodiment of the present invention;

FIG. 9 represents a schematic view illustrating relationships among agreements and licenses;

FIG. 10 represents another schematic view illustrating relationships among agreements and licenses; and

FIG. 11 represents a schematic drawing of an embodiment of a system according to the present invention.

### DETAILED DESCRIPTION OF EMBODIMENTS OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

The present invention permits the protection of intellectual property embodied in software. By managing software, such as controlling access and copying, companies can ensure that they retain ownership of their software. The present invention can enable companies to satisfy contractual commitments related to incorporation of third party software. Control of software through the present invention can also help to ensure that no revenue software license sales are lost. By managing agreements and licenses, the present invention can be utilized to generate revenue from software update services via subscriptions. Furthermore, embodiments of the invention can facilitate generation of revenue from expansions of installed system software, through control of the number of users and new applications, among other elements. Also, the present invention can identify software as a separate orderable nomenclature with its own price structure. Embodiments of the present invention can formalize the order entry and manufacturing process of software and software services. Significantly, the present invention can track software usage.

Typically, in obtaining software, a customer signs an agreement with a software provider. The software provider may or may not be the author of the software. The agreement typically includes certain license terms that may, among other things, give the buyer rights to certain aspects of the software, permit a certain number of copies to be made, permit a specified number of users, and/or provide access to updated software.

The present invention helps to electronically, typically remotely, manage aspects of software licenses and associated functions. The present invention can provide web-based license register. Through the invention, licensees can obtain registration keys for new software versions whenever needed. New keys may be generated and downloaded new keys directly from the system according to the invention. Although the present invention is web-based, certain aspects may still be carried out through the post. For example, license certificates and agreements may be sent by mail as part of the initial software delivery.

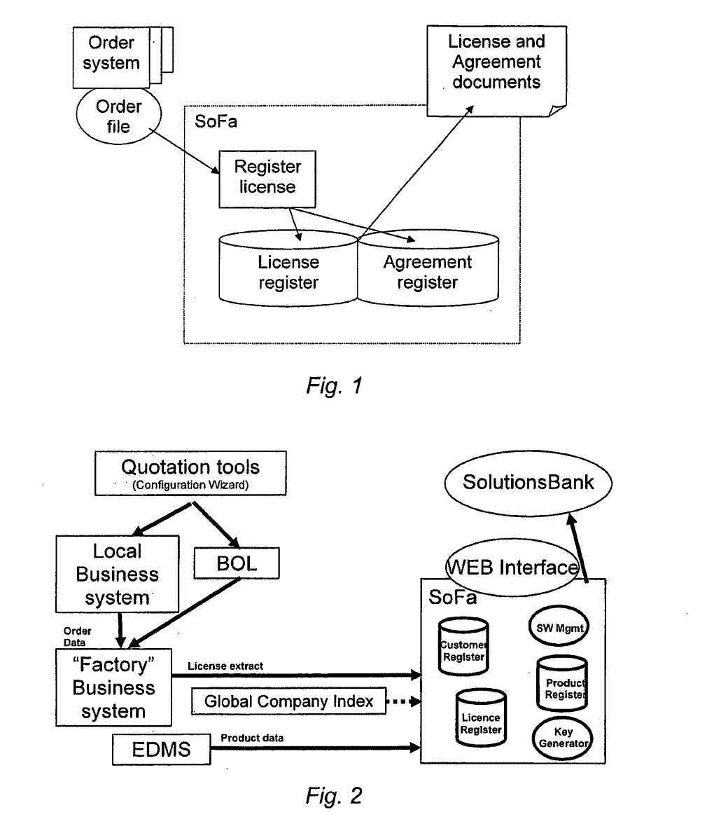

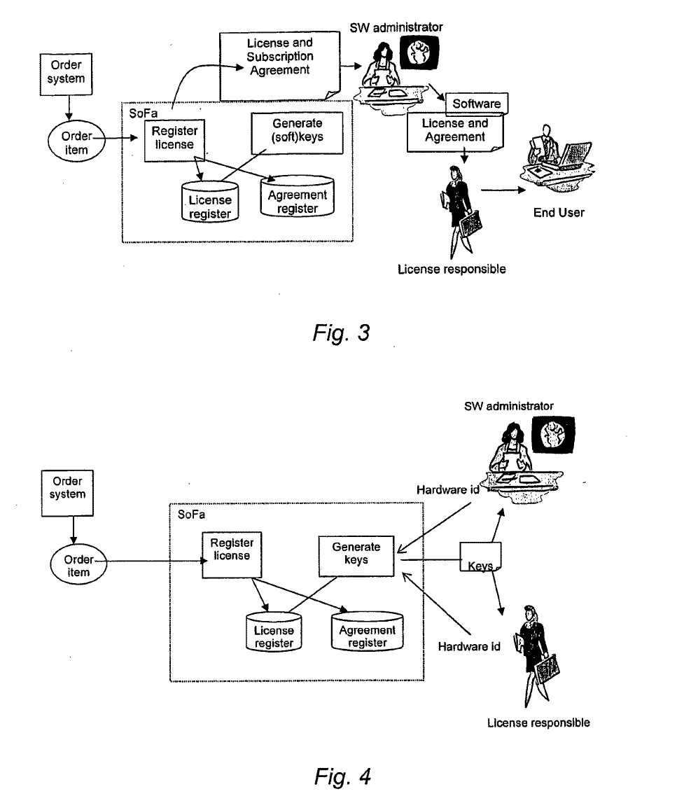

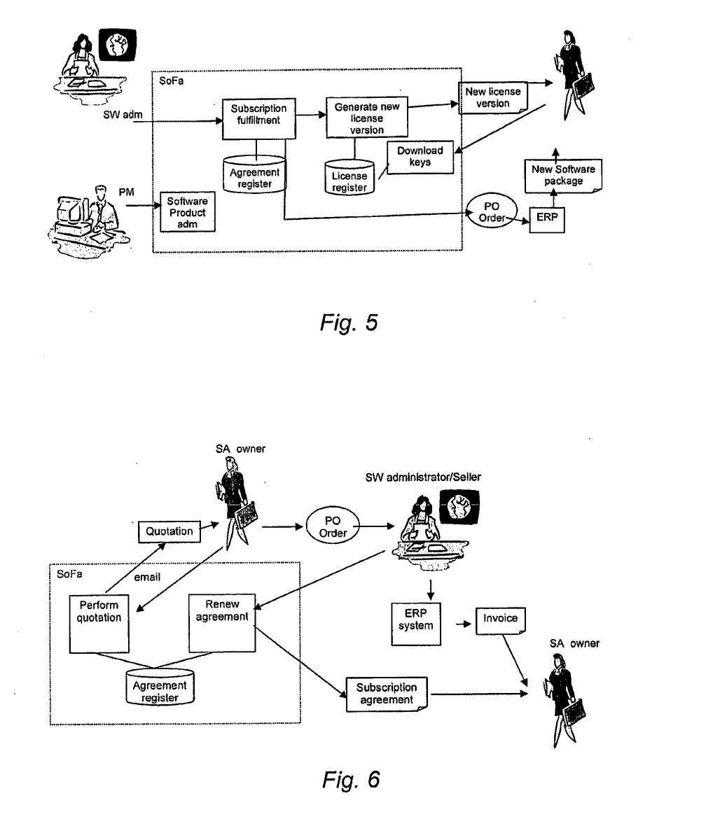

FIG. 1 schematically illustrates elements of a system according to an embodiment of the present invention and interaction of the system with an ordering system. FIG. 2 schematically illustrates additional elements of the ordering system and another embodiment of a system according to the present invention. FIGS. 3-6 schematically illustrate embodiments of the system according to the present invention and interaction of the system with various parties related to use and administration of the software.

The present invention can permit remote checking of agreement data, product licenses, and status. Additionally, through the present invention, software agreements may be combined. The system according to the invention may be customized by defining who should be notified via e-mail when new software upgrade versions are available and who should receive the upgrades. Information on new software revisions or service packs may be made available through the invention or other means. The present invention may automatically generate sales renewal notices and send them via e-mail to a customer contact person to initiate a renewal extension for a 12 month, 36 month or other length period.

The present invention represents a major advantage in the delivery process for software as the media or download of the product can be the same for all customers. The software key can be utilized to control the scope of use of the software by the customer. Having the license and key generation application available electronically through the present invention, such as through the internet or an intranet, can allow almost immediate access to the purchased software key.

A license registry according to the present invention may permit tracking of customers that are entitled to receive upgrades of the software as a part of a subscription program and to create quotations for a prolonged subscription. The system according to the invention, which may be referred to herein and in the drawings as the “Software Factory” or “SoFa”, can provide a global license management system. For example, the system can keeps track of all software licenses used by a customer. Through monitoring of the licenses, the system can provides efficient distribution of new software versions, generating software keys and downloads via the internet.

In the context of the present invention, a software license is typically a document that defines what software a customer has legal rights to use. On the other hand, a license defines what options of a product that the customer has a right to use. An Agreement can consist of one or more licenses. Each agreement may include one or more links to, for example, owner, upgrade receiver, license data and/or quotations. Software (license) keys are a mechanism by which the agreed to items in the software license can be enforced at the product level. The present invention may be utilized as a support tool of the processes for registration of new software licenses, expansion of licenses, generation of software keys, software subscription and agreement renewal, license upgrade and fulfillment license and/or other functions.

The present invention may store both agreements and licenses and provide on-line access to one or both. Each license may be linked to one or more end users and/or owner and order data, among other elements. Where applicable, the licenses may also include a link to the software agreement. A user can generate a license key that should be used in the purchased product application to make it work. To generate the keys, the license typically is tied to a hardware identity, such as an Ethernet address or a key dongle, of the computer where the product is executed. The key files may be downloaded from the system of the invention and installed in the purchased product application.

The data records stored in SoFa may define the content and validity period of the agreement. The data records may be presented on-line by access to the SoFa web pages.

The present invention may control access to functions of the system and the software. Along these lines, users of SoFa may have different kinds of accounts, depending on what kind of work they usually are involved in. The accounts may be defined as roles with a predefined set of actions and page access. Each user account may be tied to the company where the user is employed and in most cases to a group of companies.

One example of a type of user is the local system administrator. The local system administrator typically manages, creates, deletes, and/or changes user accounts. The local system administrator may also create and delete user accounts for the customer's organization. The local system administrator may allocate company Id's into company groups, perform all tasks of a purchaser.

A purchaser is another type of user that may be defined according to the present invention. The purchaser may run an aspect of a business that will utilize the software. Typically, the purchaser is from a project or service sales. Contact people listed as “License Responsible” or “Agreement Owner” in the Software Factory may have a Purchaser user account as well. The authority of the purchaser and/or any other user class may be defined to have any desired level of access.

Another type of user that may be defined in a system according to the present invention is the service user. A service user may check the licenses of a customer and install software. Typically, the service user is a person from sales, field service, project and/or commissioning staff, for example. Among the actions that a service user may be authorized to take are generating software keys, downloading key-files, creating temporary licenses, engineering and commissioning the software, and/or maintaining licenses, such as by organizing them according to the customer's needs.

Yet another user category that may be defined is the license end user. The license end user may maintain licenses, organize licenses, administer users within a company, generate software keys, download key-files, view licenses and/or groups' licenses in folders.

Users may be grouped by company or a unit in a company and may be identified by a company Id. The company Id may define the area of visibility within Software Factory for licenses and agreements. That means that the scope of a certain Software Factory user may be restricted to licenses and agreements for the company Id the user belongs to.

Companies may be grouped according to the present invention. For example, there may be two types of companies in Software Factory: “normal” companies and “group” companies. A “group” company may include a collection of companies and may be used as the profile company for all user accounts with a scope beyond one single company Id (Local System Administrator, Purchaser, and Service.User). Typically, the Central System Administrator can add other company Ids to a “group” company.

Companies may be registered based upon data provided in order files. Some companies may have several records. To enable the user access to all licenses for a company, all company ids' for the company may be put in a group. A group can also consist of other combinations. A group can consist of other groups, and by using this method a hierarchy can be generated allowing different levels of users the possibility to work only with a selection of licenses.

A user can search for a License or an Agreement by several criteria's, such as order number, End User, product and owner. The result list can be limited by, for example, date and status.

In addition to characterizing users and the scope of their access, the present invention may generate profiles to customers and users. For example, the present invention may create an address profile that characterizes licenses and agreements. For example, a license may have an “End User” and a “License Responsible” data field. An organizational unit may be characterized by its company Id and specified as “License Responsible”. Addresses may be automatically transferred to the system according to the present invention as order processing system when an initial software order is executed.

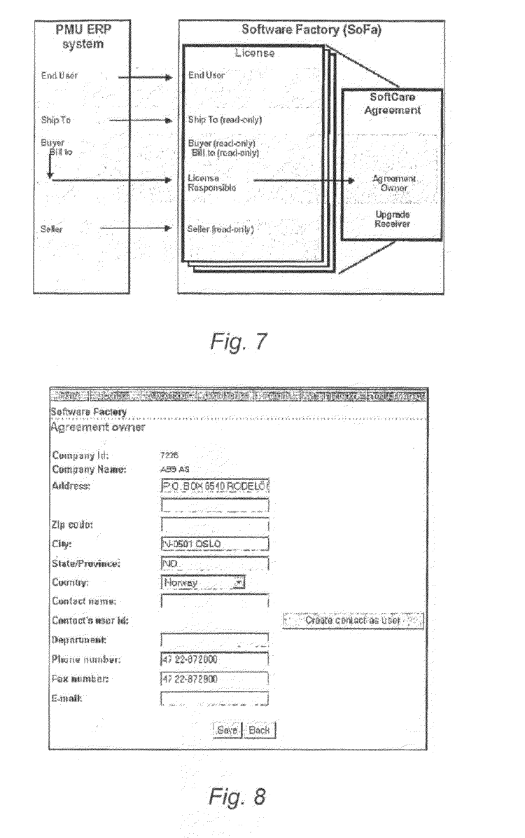

FIG. 7 illustrates different profile data for entities that may be involved in Software Factory and an ordering system identified by PMU ERP system. The arrows in FIG. 7 show data that may be automatically copied during the initial software order process from the ordering system into Software Factory.

The following represent address profiles that may be included in the ordering system and may be of interest in the present invention:

Associated with a license:
End User
License Responsible
Buyer

Associated with an agreement:
Agreement Owner
Upgrade Receiver
Sales Channel

One example of an address profile is the License Profile. The license profile may include more than one profile. For example, the license profile may include an end user profile, a license responsible profile and/or other profiles. The End User address profile typically is utilized for the owner of the license on the license certificate. The data in this field may be used for an End User company name on a Welcome Letter, a License Certificate, an agreement, a Renewal Quotation, an Upgrade Notification, a Renewal Notification and/or other aspects of the agreement/license process. Defining the end user address profile in this manner may be helpful for security purposes to ensure that external users will only see licenses under their own company. Data may be copied from the initial order from the “End User” field in the ordering system.

Another address profile that may be defined is the license responsible profile. This may include a part of a company responsible for the end-customer that owns the license. Usually this is a technical department responsible for customer proposals. This could also be the project sales organization, or the product sales channel for a system sold by system integrators. The data in this field may be utilized as the company name on the license certificate. This license certificate is shipped with the initial software (license), or when expanding, or upgrading licenses. The data in the license responsible address profile may also be utilized when doing a search function within Software Factory this field is used to find all licenses belonging to the “License Responsible” unit. Furthermore, in some cases, the data in the license responsible address profile may also be utilized for security purposes to ensure that ABB internal users will only see licenses under their own company. The data may be copied from the initial order from the “Technical Buyer” field in the ordering system. “Ship To”, “Buyer”, and “Seller” may also be copied from the ordering system at the initial software order.

In addition to generating address profiles, the system according to the present invention may generate agreement profiles. A number of different agreement profiles may exist. One example of an agreement profile is the agreement owner. The agreement owner could be a contact name provided on an agreement, a welcome letter, a key generation form, a renewal quotation, an upgrade notification, a renewal notification and/or other forms. The agreement profile could be utilized to identify where to send an agreement invoice when it has been renewed. The profile could also be utilized when doing a search function within the Software Factory to find all agreements belonging to this “Agreement Owner” profile. Usually the unit of the “Purchaser” is specified as “Agreement Owner”. The data may initially be copied from the “License Responsible” field of the first license in an agreement. If the “Agreement Owner” profile is empty, the “Local System Administrator” profile may be addressed instead.

The agreement profile may also or alternatively include the “Upgrade Receiver”. The upgrade receiving may be the address utilized when media as part of an agreement fulfillment is shipped. This should be the organization in charge of doing the service for the system specified, such as a self-provider customer or system integrator, for example. The data in this field could be used for sending media with software upgrades. The data could also be utilized in sending the upgrade notification. In this case, the upgrade notification may only be e-mailed to the “Upgrade Receiver”, if the contact email field is not blank. It may also be printed on the Upgrade. Notification under Upgrade Receiver. Additionally, the data in the upgrade receiver could be utilized in sending renewal notification. The renewal notification might only be e-mailed to “Upgrade Receiver”, if the contact email field is not blank. This profile may initially be empty and may need to be updated by the “Purchaser” responsible for an agreement. If the “Upgrade Receiver” profile is empty, the “Agreement Owner” may be utilized instead. Also, if the contact e-mail field of the “Upgrade Receiver” profile is empty, no email information may be sent. Therefore, this field may be used to prevent the Software Factory from sending any agreement/order related information by e-mail to unauthorized end-customers.

All profile data fields that may be utilized according to the present invention may include one or more or all of the following data: Company Id, Company name, Street Address, Zip code, City, State/Province, Country, Contact information, Contact name, Department, Telephone, Fax, and/or E-mail address. FIG. 8 illustrates a data entry screen that may be utilized with a user interface according to the present invention. All communication, distribution of information and shipment of media is based on the information stored in one or more of the profiles discussed above. Up-to-date data is important for the proper execution of Software Factory. It is the responsibility of the “Local System Administrator” and “Purchaser” to maintain this data. Normally an update of the profile data would be done once a year when a new agreement renewal quotation is prepared.

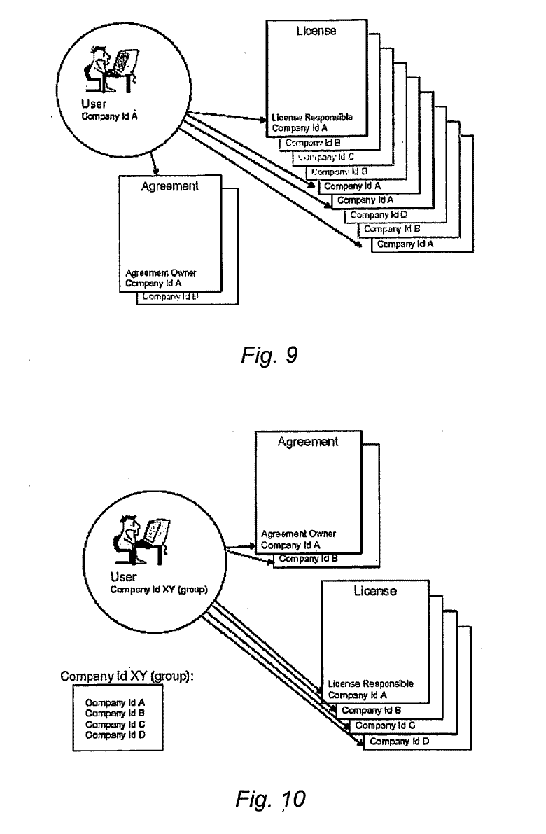

The present invention may also include a company grouping. The company grouping may include data on the scope of a company. Creating a company grouping can permit a user belonging to a certain company to see all licenses and agreements where the “License Responsible” and “Agreement Owner” is the user's company. This can also be utilized to prevent the user from viewing licenses or agreements from other companies. This is illustrated in FIG. 9.

To facilitate use of the system, companies with many different project and service units may be linked. Along these lines, different project and service units, with different company Id's, working together in an organization could cause a lot of extra administration work, to transfer the licenses and agreements between these units. To reduce the administration overhead, companies can be put into a company of type “group” in the Software Factory. All units working together, such as projects groups and service, may be members of one group and may be authorized to see and work with the licenses and agreements of all the units in this group. This is illustrated in FIG. 10.

The system may be set up such that a company can only be added to a group company by a central system administrator. A user account may be designated as belonging to a group if the company in the user profile is a company of type “group”. This profile setting may be changed by a local system administrator. The group structure can be adapted very flexible to organizational structures allowing cascading structures like groups belonging to a group. This may be carried out by a central system administrator in the same way as described above for “normal” companies.

A process according to the present invention may begin with an order. An order entry process may accept both article number based orders as well as nomenclature based. The input data format may be an xml file designed to hold all necessary data, generated from a business system at any site that uses SoFa. The order files may transferred to SoFa both at first registration and at change events. Manual order entry is also possible.

A scheduled batch job may pick up all new order files once every hour. The content is validated, and if found acceptable the order is stored and simultaneously the license and the agreement are generated.

If a customer wants to expand a license, a new purchase order for the additional functionality may be issued. The order file includes the original licenses identity as reference. In SoFa a separate expansion table for each product may define the possible steps.

As described above, software key generation may be carried out with the system according to the present invention. SoFa may include several key mechanisms. For example, the system may include information for many products with homegrown keys, originally developed for other tools than SoFa but now collected to make it easier for the users. To create a key, the system may user look up the license and type in the hardware identity of the system where the software should execute. SoFa may then generate a license key that can be a printable document or a file for download.

If for some reason, such as hardware failure, the license has to be moved, it is possible to regenerate the key with the new hardware identity. All such events may be logged to enable tracking of abuse.

The system according to the present invention may be utilized for software subscription and agreement renewal. Agreements may be created at the same time as licenses based upon order data. To reflect customers' demands as much as possible, licenses can be moved from one agreement to another, and the expiration date can be set to match, for example, the fiscal year. At some point prior to the expiration date of an agreement, a quotation proposal may be generated, that the agreement owner can use in negotiations for a new subscription period with the customer. This may occur at a point prior to the expiration date. According to one example, the proposal is generated three months prior to the expiration. It is also possible to create quotations manually. Moving licenses or setting new expiration dates may result in new quotations as the content or the validity period of the agreement has changed. When the negotiations with the customer are finalized the quote may be utilized as a reference in an upgrade order that is issued and sent to the agreement administration department. When an agreement is created or renewed a mail is sent to the order system administrator who sets up or prolongs a user account. From the order system, a user can download patches and bug fixes as well as documentation. E-mail messages may also be sent from SoFa to the agreement owner when a quotation is created and when a licensed product has been upgraded.

The system according to the present invention may also execute license upgrade and fulfillment. When a new version or revision of a product is released, a batch job may be run in SoFa that upgrades all licenses in valid agreements and initiates both the mail function mentioned and also an xml document that may be used as input to the process of producing and distributing the upgrade media to the address specified in the agreement.

The system according to the present invention may be built around three major parts, product data, key mechanisms, and user, company, order and license data. Product data may be set up in a strict tree hierarchy that can include more or more of the following categories: product category, product, product option group, product option and product feature. Product Category may include one or more products. Product may include one entry for each product version. Product OptionGroup may include one or more options. Product Option may include the sold function and a unique choice. Product feature may control the key settings. Product Options may be set up to be scaled by one of quantity, or one of many, or quantity in an interval. Product data may also include price lists used for one or more different purposes, such as to connect a particular article number with a specific option in the license registration process or to calculate the subscription renewal cost for a licensed option, and/or other purposes.

To enable expansion orders, the present invention may include a separate setup that defines the possible expansion steps.

Key mechanisms may in many cases include executable programs that SoFa calls upon during the key generation process. These programs can include simple ones that just return a fixed value independent of what the user entered and complicated ones that calculate several different keys and return a coded file including a checksum.

For administrators with many and/or huge installations it can be difficult to get a good overview of all records. To make this easier, the system according to the invention may include the possibility to create folders where several licenses or several agreements can be collected. The creator of the folder can give access to the folder to other users. The system according to the present invention can generate several different reports for the users. One of these reports can help find all agreements for a customer. The reports can be exported, for example, to Microsoft Excel format, for further analysis work.

The following provides order file examples.
Article number based:

<\xml version=“1.0” encoding=“ISO-8859-1”\>
<MESSAGE xmlns=“x-schema:d:\SoFa\Template\
SofaOrderMessage105.xml”
SENDER=“SEAPR” SENDINGDATE=“2005-12-21”
SENDINGTIME=“08:00:17”>
<ORDER ORDERID=“10224853” ORDERDATE=“2005-12-20”
ORDERTYPE=“SO”
DELIVERYDATE=“2006-02-14”>
<SELLINGBUCODE>4464</SELLINGBUCODE>
<PURCHASINGCODE>SVPA</PURCHASINGCODE>
<PURCHASEORDER>92040_57</PURCHASEORDER>
<ORDERPARTNER PARTYQUALIFIER=“BY” PARTYID=“944807”>
<COMPANYNAME>ABB AB</COMPANYNAME>
<ADDRESS1/>
<ADDRESS2/>
<CITY>MÖLNDAL</CITY>
<ZIPCODE>43187</ZIPCODE>
<COUNTRYCODE>SE</COUNTRYCODE>
<CONTACTPERSON>Sture Nilsson</CONTACTPERSON>
<CONTACTPHONE/>
<CONTACTFAX/>
<CONTACTEMAIL>sture.w.nilsson@se.abb.com</CONTACTEMAIL>
</ORDERPARTNER>

The order partner information is repeated for:

<ORDERPARTNER PARTYQUALIFIER=“IV” PARTYID=
“10015627”>
<ORDERPARTNER PARTYQUALIFIER=“DP” PARTYID=
“501033127”>
<ORDERPARTNER PARTYQUALIFIER=“SE” PARTYID=“SEAPR”>
<ORDERPARTNER PARTYQUALIFIER=“EU” PARTYID=“N/A”>
<ORDERITEM ITEMID=“100” ORDERITEMTYPE=“B”>
<ITEMDESCRIPTION>AC 400 Series</ITEMDESCRIPTION>
<LICENSEID> </LICENSEID>
<PRICELISTID>3BSE014309/V</PRICELISTID>
<QUANTITY>1<QUANTITY>
<UNITPRICE>131219.17</UNITPRICE>
<UNITCOST>34701.82</UNITCOST>
<ORDEREDOPTION OPTIONID=“3BSE020200R1”>
<OPTIONNAME>AdvaControl Basic Functions Licence
</OPTIONNAME>
<QUANTITY>1<QUANTITY>
</ORDEREDOPTION>
<ORDEREDOPTION OPTIONID=“3BSE020201R1”>
<OPTIONNAME>AdvaControl Incremental Licence for
</OPTIONNAME>
<QUANTITY>1</QUANTITY>
</ORDEREDOPTION>
</ORDERITEM>
<COMMENT SEQUENCENUM=“1”>
<COMMENTTEXT>Project name:ISSUER-051114-00 Mönsterås
</COMMENTTEXT>
</COMMENT>
</ORDER>
</MESSAGE>

The following provides an example of nomenclature based:

<\xml version=“1.0” encoding=“ISO-8859-1”\>
<MESSAGE xmlns=“x-schema:d:\SoFa\Template\
SofaOrderMessage105.xml”
SENDER=“SEAPR” SENDINGDATE=“2005-12-21”
SENDINGTIME=“08:00:17”>
<ORDER ORDERID=“10224853” ORDERDATE=“2005-12-20”
ORDERTYPE=“SO”
DELIVERYDATE=“2006-02-14”>
<SELLINGBUCODE>4464</SELLINGBUCODE>
<PURCHASINGCODE>SVPA</PURCHASINGCODE>
<PURCHASEORDER>92040_57</PURCHASEORDER>
<ORDERPARTNER PARTYQUALIFIER=“BY” PARTYID=“944807”>
<COMPANYNAME>ABB AB</COMPANYNAME>
<ADDRESS1/>
<ADDRESS2/>
<CITY>MÖLNDAL</CITY>
<ZIPCODE>43187</ZIPCODE>
<COUNTRYCODE>SE</COUNTRYCODE>
<CONTACTPERSON>Sture Nilsson</CONTACTPERSON>
<CONTACTPHONE/>
<CONTACTFAX/>
<CONTACTEMAIL>sture.w.nilsson@se.abb.com</CONTACTEMAIL>
</ORDERPARTNER>

The order partner information may be repeated for:

<ORDERPARTNER PARTYQUALIFIER=“IV” PARTYID=
“10015627”>
<ORDERPARTNER PARTYQUALIFIER=“DP” PARTYID=
“501033127”>
<ORDERPARTNER PARTYQUALIFIER=“SE” PARTYID=“SEAPR”>
<ORDERPARTNER PARTYQUALIFIER=“EU” PARTYID=“N/A”>
<ORDERITEM ITEMID=“001”>
<PARTNUMBER>SSBSHAPI</PARTNUMBER>
<ITEMDESCRTPTION>SEMAPI SIMULATION INTRFC.
</ITEMDESCRIPTION>
<NOMENCLATURE>SS-B-SHAPI-A010510000000000
</NOMENCLATURE>
<QUANTITY>000001.000</QUANTITY>
<UNITPRICE>00000003150.000</UNITPRICE>
</ORDERITEM>
</ORDER>
</MESSAGE>

The following illustrates steps that can be involved in one exemplary embodiment of the present invention. This is only one illustrative embodiment and many other are possible. The example includes activities involved in setup of the Software Factory and the order system.

### Step 1

System presentation. Identify the appropriate people for the different roles needed. Define one or more Local System Administrators for the different units in the organization.

### Step 2

Forward a request to create Local System Administrator accounts to the Central System Administrator in the ordering system. Train the Local System Administrator. A Software Factory user's manual is available for Local System Administrator.

### Step 3

The Central System Administrator creates the accounts and returns an email with user name and password.

### Step 4

Define one or more Purchasers for the different units. The Purchaser or the Local System Administrator needs to maintain all the profile data. They also need to be able to generate and download keys within their local business unit.

### Step 5

Identify the responsible persons within the Purchaser service organization for customers who have outsourced their service to the Purchaser. Define one or more Purchasers for the different units. The Purchaser or the Local System Administrator needs to maintain all the profile data. Define Service User for the unit. They also need to generate and download keys within their local business unit.

### Step 6

The Local System Administrator creates accounts for Purchaser and Service Users in his unit. Train the Purchaser and Service User. A Software Factory user's manual is available for both Purchaser and Service User. Inform Purchaser and the contacts listed under “License Responsible” and “Agreement Owner” about their tasks.

### Step 7

Identify customers (such as System Integrators) who do their own service and install the software themselves. Identify the responsible person within the customer organization.

### Step 8

The Local System Administrator creates “End User” user accounts for these customers. The customer contact persons are trained in using Software Factory and are informed about the possibilities and the processes being used. A “License End User” guide is translated to local language and provided for the customer.

### Step 9

The Purchaser updates profile data for “License Responsible”, “End User”, and “Upgrade Receiver”. The e-mail address in “Upgrade Receiver” is kept blank if customer or any other person should not receive ordering system notifications.

### Step 10

The purchaser identifies groups needed in the organization. The request is forwarded to the Central System Administrator in the ordering system.

### Step 11

The Central System Administrator creates the companies of type “group” as requested.

### Step 12

The Local System Administrator will then place Software Factory users of his unit into the group by changing the company Id in their profile to the “group” company. Allocating a company group for project units and service units dealing with the same customers can reduce the administration work.

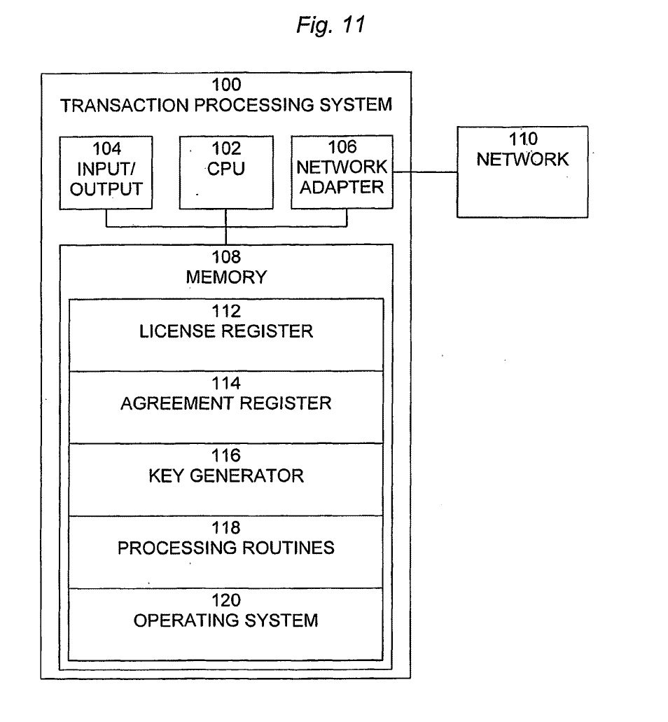

An exemplary block diagram of a software management system 100, according to the present invention, is shown in FIG. 11. Software management system 100 is typically a programmed general-purpose computer system, such as a personal computer, workstation, server system, and minicomputer or mainframe computer. Software management system 100 includes processor (CPU) 102, input/output circuitry 104, network adapter 106, and memory 108, CPU 102 executes program instructions in order to carry out the functions of the present invention. Typically, CPU 102 is a microprocessor, such as an INTEL PENTIUM® processor, but may also be a minicomputer or mainframe computer processor. Input/output circuitry 104 provides the capability to input data to, or output data from, computer system 100. For example, input/output circuitry may include input devices, such as keyboards, mice, touchpads, trackballs, scanners, etc., output devices, such as video adapters, monitors, printers, etc., and input/output devices, such as, modems, etc. Network adapter 106 interfaces transaction processing system 100 with network 110. Network 110 may be any standard local area network (LAN) or wide area network (WAN), such as Ethernet, Token Ring, the Internet, or a private or proprietary LAN/WAN.

Memory 108 stores program instructions that are executed by, and data that are used and processed by, CPU 102 to perform the functions of the present invention. Memory 108 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 108 includes a plurality of blocks of data, such as license register block 112, agreement register block 114, key generator block 116, and a plurality of blocks of program instructions, such as processing routines 118 and operating system 120. License register block 112 stores a plurality of licenses that have been received by software management system 100. Agreement register block 114 stores a plurality of software agreements that may be relevant to one or more software elements related to the licenses. The key generator block may generate keys for different users based upon the licenses. Processing routines 118 are software routines that implement the processing performed by the present invention. Operating system 120 provides overall system functionality.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A software management method, comprising:
storing customer identifying information in a customer register;
storing a subscription agreement of a customer in a subscription agreement register;
creating at least one license corresponding to the subscription agreement;
storing the license in a license register;
generating at least one key corresponding to a scope of the license; and
providing the key to the customer.

2. The method according to claim 1, further comprising:
assigning an authority level to at least one user; and
providing the at least one user with access to the software commensurate with the authority level.

3. The method according to claim 1, wherein the at least one key is generated based at least in part upon hardware identification information received from the customer.

4. The method according to claim 1, further comprising:
determining whether the customer has a valid agreement, and
generating an upgrade of the license commensurate with the software product version upgrade.

5. The method according to claim 1, further comprising:
altering the agreement; and
registering the altered agreement.

6. The method according to claim 1, further comprising:
altering the license;
registering the altered license; and
generating at least one new key corresponding to the altered license.

7. The method according to claim 1, further comprising:
renewing the agreement; and
registering the renewed agreement.

8. The method according to claim 1, further comprising:
initiating distribution of updated software.

9. The method according to claim 1, wherein the user remotely initiates generation of the key.

10. The method according to claim 1, further comprising:
combining agreements.

11. The method according to claim 1, further comprising:
determining users authorized to receive updated software;
notifying the authorized users of the updated software; and
initiating distribution the updated software to the authorized users.

12. The method according to claim 1, wherein the users include at least one of a local system administrator, purchaser, service user, or license end user.

13. A computer program product for performing a software management process in a system, comprising:
a computer readable medium; and
computer program instructions, recorded on the computer readable medium, executable by a processor, for performing the steps of storing customer identifying information in a customer register;
storing a subscription agreement of a customer in a subscription agreement register;
creating at least one license corresponding to the subscription agreement;
storing the license in a license register;
generating at least one key corresponding to a scope of the license; and
providing the software and the key to the customer.

14. A system for performing a software management process, comprising:
a processor operable to execute computer program instructions; and
a memory operable to store computer program instructions executable by the processor, for performing the steps of:
storing customer identifying information in a customer register;
storing a subscription agreement of a customer in a subscription agreement register;
creating at least one license corresponding to the subscription agreement;
storing the license in a license register;
generating at least one key corresponding to a scope of the license; and
providing the software and the key to the customer.
